(19) United States
(12) Patent Application Publication
(10) Pub. No.: US 2004/0139236 A1
(43) Pub. Date: Jul. 15, 2004

(54) Virtual switch

(76) Inventors: Pankaj Mehra, San Jose, CA (US); Rahul Nim, San Jose, CA (US); James R. Hamrick, Moreno Vallley, CA (US)

Correspondence Address: HEWLETT-PACKARD COMPANY, Intellectual Property Administration, P.O. Box 272400, Fort Collins, CO, 80527-2400, US

(21) Appl. No.: 10/339,146

(22) Filed: Jan. 9, 2003

(51) Int. Cl. G06F 15/16; G06F 15/173

(52) U.S. Cl. 709/250; 709/238

(57) ABSTRACT

An electronic system comprises a processor, network interface controller (“NIC”) and a virtual switch. The virtual switch may comprise software executed by the processor and may include a plurality of virtual ports. The virtual ports may provide communications with an application running on the processor and the network interface controller.

### BACKGROUND

Computer networks may comprise various end nodes coupled via one or more switches. A switch generally comprises multiple ports and circuitry that receives messages over an input port and forwards such messages out through an output port. As networks grow in complexity and size, switch circuitry also grows in complexity.

A node may comprise a computer having one or more processors that execute one or more applications that perform a variety of functions (e.g., data processing and network management). A node also may have one or more network interface controllers (“NICs”) that provide the node access to the network. Via a NIC, a node can send or receive packets to or from other nodes in the network. In some implementations, a packet may contain “source route” information which generally specifies the output ports of the end node and various intervening switches that the packet is to follow to traverse the network. As such, the source route information provides directions to the network to permit the network to deliver the packet from source node to destination node.

The source route information provides enough information to permit the packet to reach the NIC of the destination node. Generally, the intelligence for managing source-routed networks is concentrated inside the node's operating system device drivers because that is where the packet forwarding logic typically is located. As such, the management applications are not part of the source routing paradigm which creates inefficiencies in how packets are transferred between management application processes and NIC drivers. Any improvements in this area that can make for a more efficiently operated network and/or provide more functionality is desirable.

### BRIEF SUMMARY

One or more of the problems noted above may be solved by an electronic system comprising a processor, network interface controller (“NIC”) and a virtual switch. The virtual switch may comprise software executed by the processor and may include a plurality of virtual ports. The virtual ports may provide communications with an application running on the processor and the network interface controller. The electronic system may include a network having a plurality of end nodes and at least one switch. Each end node may comprise an electronic system such as that described herein.

### BRIEF DESCRIPTION OF THE DRAWINGS

For a detailed description of the preferred embodiments of the invention, reference will now be made to the accompanying drawings in which:

FIG. 1 shows a system including end nodes and switches in accordance with embodiments of the invention;

FIG. 2 shows a more detailed block diagram of an end node and includes a virtual switch in accordance with embodiments of the invention; and

FIG. 3 shows a flow chart exemplifying the forwarding logic implemented in the virtual node of FIG. 2 in accordance with embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .”. Also, the term “couple” or “couples” is intended to mean either an indirect or direct electrical connection. Thus, if a first device couples to a second device, that connection may be through a direct connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted or otherwise used as limiting the scope of the disclosure, including the claims, unless otherwise specified. In addition, one skilled in the art will understand that the following description has broad application, and the discussion of any embodiment is meant only to be exemplary, and not intended to intimate that the scope of the disclosure, including the claims, is limited to these embodiments.

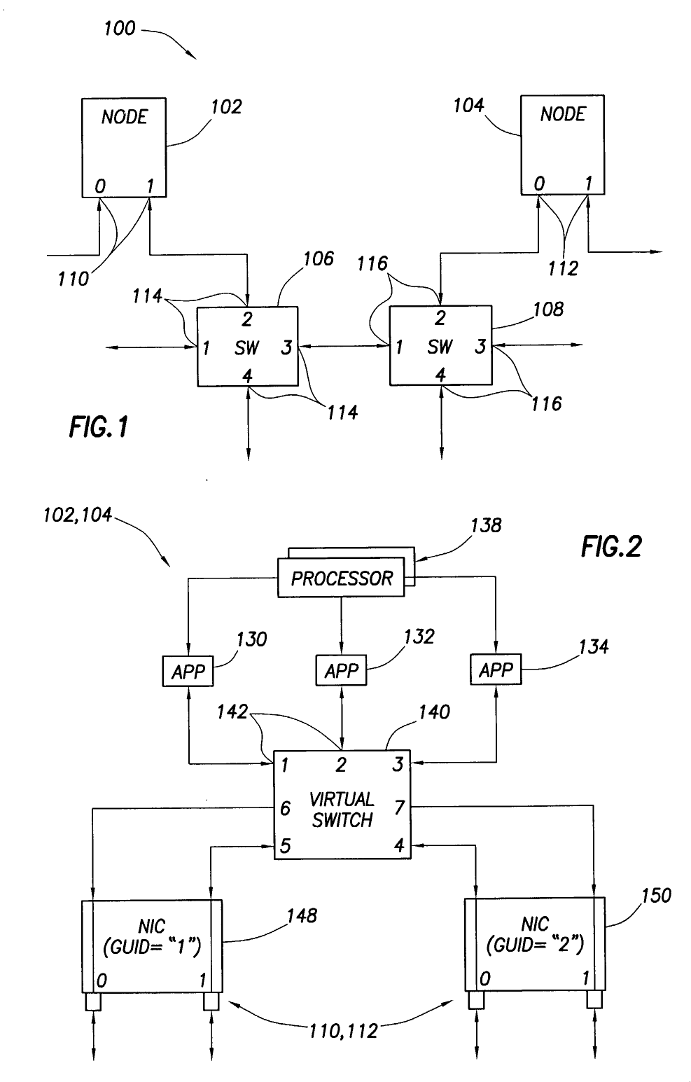

Referring now to FIG. 1, an exemplary network 100 may comprise end nodes 102 and 104 and switches 106 and 108. As shown, node 102 couples to switch 106 which, in turn, couples to switch 108. Switch 108 also couples to node 104. Packets (e.g., data packets, management packets, etc.) may be transmitted back and forth between nodes 102 and 104 via switches 106 and 108. It should be understood that the topology depicted in FIG. 1 is exemplary of numerous possible topologies. More than two nodes may be included in the system and any number of switches (i.e., one or more) may be used to create the network infrastructure.

Each end node 102, 104 may comprise a computer system having one or more processors, volatile memory, non-volatile memory (e.g., hard drive, CD ROM, etc.), an input device (e.g., keyboard, mouse, etc.) and an output device (e.g., a display). An end node may also comprise devices other than computers. For example, an end node may comprise a network storage device.

The switches 106, 108 may comprise logic that receives packets and forwards such packets on to other switches or nodes. For example, switch 106 may receive packets from node 102 and forward such packets to switch 108. Switch 106 may also receive packets from switch 108 and forward such packets to node 102. Switch 108 functions similarly by forwarding packets received from switch 106 to node 104 and from node 104 to switch 106.

Each node 102, 104 and switch 106, 108 may include one or more hardware ports 110, 112, 114 and 116 which permit connection to other nodes/switches. As shown, each end node 102 includes hardware ports 110, while end node 104 includes hardware ports 112. Switch 106 may include hardware ports 114, while switch 108 may include hardware ports 116. Each port is assigned a port identifier (also called a “port number”) which is used to construct the source route information described below. For example, the hardware ports 110, 112 associated with nodes 102 and 104 may have port identifiers “0” and “1” as shown. Switches 106 and 108 each may have four ports having the port identifiers “1,” “2,” “3,” and “4” as shown. Ports 1 and 4 on switches 106 and 108 may be used to connect to other switches or nodes (not shown). Although end nodes 102 and 104 are shown in FIG. 1 as only including two hardware ports 110, 112, the nodes may include any number of hardware ports desired. Similarly, switches 106, 108 are shown with four hardware ports each, but the switches may contain any number of ports. In some embodiments, each switch includes 16 hardware ports.

Referring briefly to FIG. 1, a request packet may be transferred from node 102 through switches 106 and 108 to node 104, and an associated response packet may be transferred in the opposite direction. The packet may contain source route information which may include a list of the output ports along the path to be traversed by the packet. For example, the request packet being transmitted from node 102 to node 104 may contain the list “3-2” within its source route string representing output port 3 on switch 106 and output port 2 on switch 108. The source route string additionally may include a direction bit and a pointer bit, and may be terminated by an “end of route” marker which may be associated with a predetermined port. The Direction Bit indicates whether the list is being used in the forward direction or the reverse direction. The pointer bit identifies the next field to use within the output port list. A pointer bit value of 1 refers to the first value in the output port list; the value 2, the second value; and so on. In the following example the construct [Fwd; 1] indicates the direction bit being set to indicate the forward direction and the value “1” represents the pointer bit, which in this example identifies the port number in the source route string that should be used to forward the packet. For example, node 102 may receive a request to transmit to node 104 via port 1 the packet containing the source route string “3-2-63 [Fwd; 1] 11 where “Fwd” indicates the forward direction and “1” is the pointer value. Node 102 may send that packet to switch 106 via a specified output port (port 1) so that the packet will arrive at switch 106 at its port 2. That packet's pointer will now specify port identifier 3 which informs switch 106 that the packet should be forwarded out through port 3 to switch 108. Prior to transmitting, the switch 106 may store the port of arrival, in this case port 2, at the current pointer location and then advance (i.e., increment) the pointer. The switch 108, therefore, will receive the packet containing “2-2-63 [Fwd; 2]” at its port 1. The switch 108 will forward the packet out of its port 2 after setting the source route string to “2-1-63 [Fwd; 3]” so that the packet will be delivered to node 104. The node 104 may create a response packet by turning the packet around using the incoming source route in the reverse direction as follows. Node 104 may send a packet containing the source-route string “2-1-63 [Rev; 2] to switch 108. In turn, the switch 108 will forward the packet containing the source-route string “2-2-63 [Rev; 1] to switch 106. Ultimately, the packet will reach its destination node 102 containing the source-route string “3-2-63 [Rev; 0]. On packets with the source route string specifying the reverse direction, a pointer bit value of 0 may signify the end of the route.

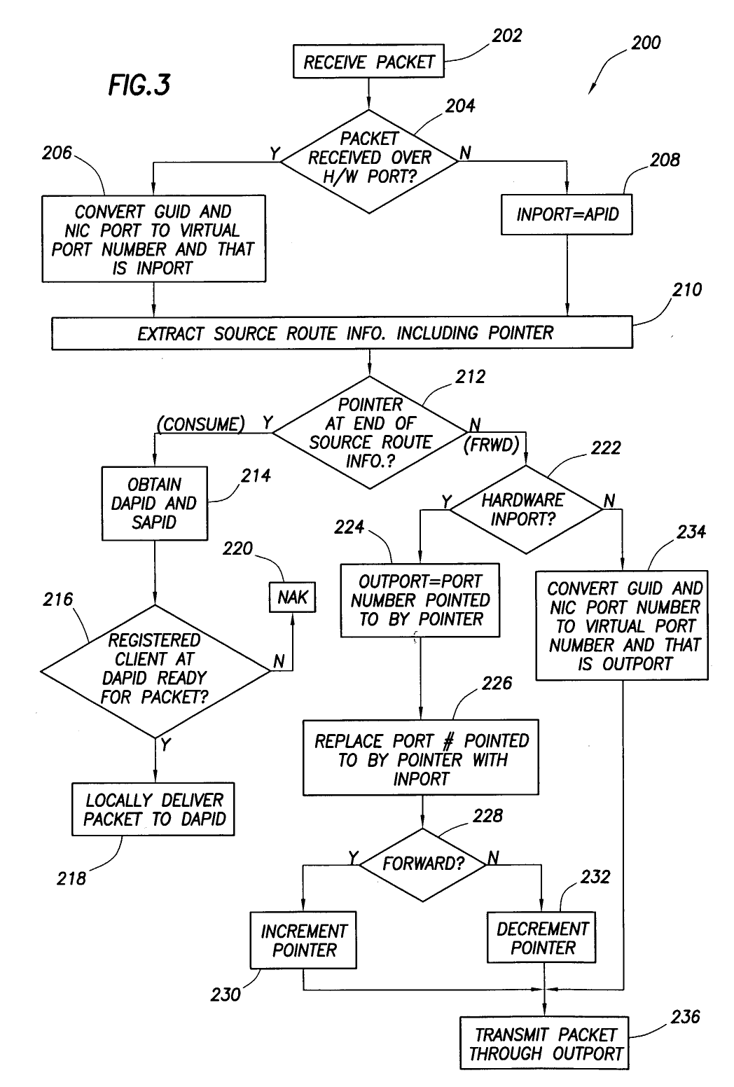

Referring now to FIG. 2, each node 102, 104 may comprise one or more applications 130, 132, and 134 running on one or more processors 138, a virtual switch 140 and one or more NICs 148, 150. Other devices (e.g., memory, input device such as keyboards, and output devices such as displays) may be included as well. The applications 130-134 may perform a variety of functions such as data processing and network management. The NICs 148, 150 provide the node access to the network. In accordance with some embodiments, each NIC may include two hardware ports, shown in FIG. 2 to have “0” and “1” as their port identifiers. The example of FIG. 2 includes two NICs 148, 150 which provide four hardware ports. However, any number (i.e., one or more) of NICs may be included in a node as desired. Each NIC also may be assigned a global unique identifier (“GUID”). For example, as shown in FIG. 2, NIC 148 may be assigned a GUID of “1” and NIC 150 may be assigned a GUID of “2.” Consequently, each of the two hardware ports on a NIC may be identified by the GUID corresponding to that NIC and the particular port number.

As introduced above and in accordance with various embodiments of the invention, anode 102, 104 includes a virtual switch 140. The virtual switch 140 may be implemented in software stored on a computer readable storage medium and may be executed by processor(s) 138. As will be explained in more detail below, the virtual switch 140 permits the source routing paradigm to be extended to the user applications space in order to allow source-routed packets to target one or more applications on a node (e.g., applications 130-134). Further, the virtual switch 140 may permit packet-forwarding logic for source routed networks, as well as multiple management functions, to be implemented as user-mode applications, rather than as device drivers. As a result, management functions may be moved out of the operating system kernel and implemented more flexibly as ordinary applications or services. It may also enable modular and distributed management applications by allowing multiple entities to share a network interface at an end node in a source-routed, packet-switched network. Application-to-application (within the same node), application-to-hardware port, and hardware port-to-hardware port communications may also be enabled with the virtual switch 140.

Referring still to FIG. 2, the virtual switch 140 may contain a plurality of virtual ports 142. In the example of FIG. 2, virtual switch 140 includes five virtual ports 142, designated for purposes of illustration by virtual port numbers 1-5. Any number of virtual ports 142 may be included. Each application 130-134 desiring access through the virtual switch 140 to the network also may be assigned one or more virtual ports 142 (referred to as application port identifiers or “APIDs”). As such, a packet originating from an application 130-134 may include source routing information that comprises virtual port identifiers 142, as well as hardware port identifiers 110, 112, 114, and/or 116 (see also FIG. 1). The applications 130-134 may assemble the source route strings without any particular awareness that some of the port identifiers may be associated with a virtual switch while other ports may be associated with hardware devices (e.g., switches). In short, the inclusion of virtual switches 140 is generally transparent to the user application space.

The virtual ports associated with the virtual switch 140 may contain any desired number of ports. In accordance with various embodiments of the invention, the virtual switch 140 may include 64 virtual port numbers. The 64 virtual port numbers (0-63) may be divided into three groups. One group includes port numbers 0 through 15 and represent hardware ports. Another group includes port numbers 32 through 62 and represents general use APIDs. The remaining port numbers 16-31 and 63 correspond to APIDs for special applications. These special purpose APIDs may be used to implement services whose clients assume a simplified discovery model by always using a well-known dedicated APID.

In accordance with representative embodiments, an application 130-134 may be registered with the virtual switch 140 to assign the application an APID. Accordingly, the application may call an initialization function to cause an APID to be assigned for that application. If desired, the initialization function call may contain an APID value that the application wishes to use. The initialization function may return an APID value that represents the APID that was granted to the application. The APID granted to the application may or may not be the same as the requested APID.

As discussed above, the virtual switch 140 may receive a packet on one of its virtual ports 142 and forwards that packet out through one of its other virtual ports. In accordance with various embodiments of the invention, the virtual switch 140 receives an incoming packet and determines the type of responsive action to take. The responsive action may be any one or more of the following: (1) to forward the packet out through a NIC hardware port 110, 112; (2) to forward the packet to one or more applications (e.g., applications 130, 132, 134); (3) to consume the packet inside the virtual switch 140 for virtual-switch configuration by a remote management entity (not shown); or (4) to reject the incoming packet, optionally generating a Negative Acknowledgement (“NACK”) response indicating invalid source route information. Thus, the virtual switch 140 generally includes forwarding logic (preferably implemented in software) that forwards incoming packets to appropriate destinations.

Referring now to FIG. 3, an exemplary packet forwarding process 200 is shown that the virtual switch 140 may implement. The virtual switch 140 may comprise executable software instructions which perform the functionality depicted in the example of FIG. 3. Process 200 begins upon the receipt of a packet (block 202) into one of the virtual ports 142 of the virtual switch 140. Blocks 204 and 206 generally determine the virtual port 142 over which the packet was received by the virtual switch 140. In decision block 204, the virtual switch 140 determines whether the packet was received into the node 102, 104 via a hardware port (e.g., 110, 112). The decision may be made by determining if the input port identifiers are within the range of port values associated with hardware ports as noted above. If the packet, in fact, was received via a hardware port 110, 112, then in block 206, the GUID and port number associated with the NIC and hardware port over which the packet was received are converted to the virtual switch port identifier 142 that is associated with that particular NIC and hardware port. In the example of FIG. 2, the virtual port identifiers associated with the hardware ports 110, 112 are “4” through “7.” The virtual switch port 142 resulting from the conversion represents the “inport” for purposes of FIG. 3 and may be used to modify the source route information as described below so as to create a source route string defining a return path for the packet if needed. For example, if a packet is received via port 1 of NIC 148 (GUID 1), that packet is provided to port 5 of virtual switch 140. Thus, the conversion process of block 206 would result in GUID 1, port 1 being converted to a value of “5” which represents the inport value.

If, per decision block 204, the packet is not received via a hardware port, control passes to block 208. In this situation, the packet was received via a virtual port 142 (“APID”). In block 208, the APID 142 is used to represent the inport value. Following completion of blocks 206 or 208, control passes to block 210 in which the packet's source route information, including the pointer, is extracted. The source route information may comprise a string of one or more port numbers (virtual and/or hardware) that identify the path through which the packet has taken or will take on its journey from source to destination. The pointer identifies (i.e., “points to”) the particular port identifier in the source route information to which the packet should be forwarded. If the pointer is pointing to the end of the source route string, then the packet is considered to be at the end of its journey and the virtual switch 140 determines that the packet should be “consumed” by the end node (i.e., processed in a suitable manner). In block 212, the virtual switch 140 determines from the source route information whether the pointer is pointing to the end of the source route string. If the answer is “yes” (indicating that the packet is at the end of the path), control passes to block 214 in which the source APID (“SAPID”) and destination APID (“DAPID”) are obtained from the packet's source route information at predetermined locations within the packet. If a client application exists on the node that is registered having the APID specified by the DAPID (decision 216), then the packet is delivered in block 218 to the destination application associated with specified DAPID. Otherwise, if no client exists that is registered with the specified DAPID, then in block 220 a response packet may be generated containing a negative acknowledgment indicating this condition.

Returning to decision block 212, if the pointer is not pointing to the end of the source routing string, the packet is forwarded on to the port to which the pointer is currently pointing. The inport, assigned as described above, may be pointing to either a hardware port or a virtual port as determined by decision block 222. In the former case (inport pointing to a hardware port), an “outport” value is computed as, or otherwise determined to be, the port number pointed to by the pointer (block 224). The outport number is the port through which the packet is to be transmitted from the virtual switch 140. In block 226, the port identifier in the source routing string currently identified by the pointer may be replaced with the inport number determined in blocks 206 or 208. This action of replacing the port identifier permits the source route information to be modified as the packet passes through the virtual switch in one direction so that if a responsive packet is sent back, the source route information for that return packet will be computed automatically. In this way, only the source node of a packet needs to know the source route information—by the time the packet reaches the destination node, the return source route path has already been computed for the destination node. If desired, the hardware switches 106, 108 may also implement the port identifier replacement process described above.

In addition to replacing the port identifier in the source route information with the inport value, the pointer may be adjusted so as to point to the port in the source route information corresponding to the next entity (switch, node, etc.) on the packet's journey through the network from source to destination. To that end, the pointer may either be incremented or decremented depending on which direction the packet is moving through the network. The “forward” direction may refer to the direction the packet takes from the source to destination. The “reverse” direction may refer to the opposite direction (i.e., from destination back to source such as for a response packet. This logic is depicted by decision block 228, which determines if the packet is moving in the forward direction, and block 230 in which the pointer is incremented if the packet is moving in the forward direction and block 232 in which the pointer is decremented for the reverse direction. By way of example, if the source route string comprises “0-4-5” and the pointer is currently pointing to the value “4,” the logic containing the packet may either attempt to transmit the packet out port 0 or port 5, depending on whether the packet is moving from port 0 through port 4 to port 5 or from port 5 through port 4 to port 0. The packet may contain a direction bit to indicate either a forward direction or a reverse direction. Thus, decision block 228 may be performed by checking the direction bit.

If decision block 222 reveals that the pointer is not pointing to a hardware port, then it may be determined that the packet is to be sent out of the virtual switch 140 through a virtual port 142. In this case, control passes to block 234 in which the NIC GUID and port number are converted to a virtual switch port number 142. The resulting virtual port number represents the outport number.

Once the outport number is determined for the packet, the packet is transmitted out through the specified outport number (block 236).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An electronic system, comprising:
a processor;
a network interface controller including a hardware port; and
a virtual switch comprising software executed by said processor and including a plurality of virtual ports, said virtual ports adapted to provide communication with an application running on said processor and said network interface controller.

2. The electronic system of claim 1 further comprising a plurality of applications running on said processor and said virtual switch includes virtual ports adapted to provide communication with each of said applications.

3. The electronic system of claim 1 further comprising a plurality of network interface controllers, each adapted to communicate with the virtual switch via a virtual port.

4. The electronic system of claim 1 wherein said application submits a requests for an application port identifier (“APID”) to use when communicating with the virtual port of the virtual switch.

5. The electronic system of claim 1 wherein said application is granted an application port identifier (“APID”) to use when communicating with the virtual port of the virtual switch.

6. The electronic system of claim 1 wherein said virtual switch permits packets to be routed from said application to said network interface controller.

7. The electronic system of claim 1 further comprising a plurality of applications running on said processor and said virtual switch includes virtual ports adapted to provide communication with all of said applications, and wherein said virtual switch permits packets to be routed from any of said applications to another of said applications.

8. The electronic system of claim 7 further comprising a plurality of network interface controllers, each having at least one hardware port, and wherein said virtual switch permits packets to be routed from any of said applications to any said network interface controllers' hardware ports.

9. The electronic system of claim 8 wherein said virtual switch permits packets to be routed from any of said network interface controllers' hardware ports to any other of said network interface controllers' hardware ports.

10. The electronic system of claim 1 wherein said virtual switch receives a packet and accesses source route information contained in the packet, said source route information includes port identifiers associated with hardware and/or virtual ports specifying the route the packet takes through a network, and said virtual switch determines whether a pointer that is also contained in the packet is pointing to a port identifier associated with a hardware port or a virtual port.

11. The electronic system of claim 10 wherein said virtual switch determines whether the packet is at the end of its route through the network and causes the packet to be consumed.

12. The electronic system of claim 11 wherein, if the packet is at the end of its route, the virtual switch determines whether an application exists that the packet is targeted for and provides the packet to that application if it exists.

13. A network, comprising:
a plurality of nodes; and
at least one switch coupling the nodes together;
wherein each of said nodes includes:
a processor;
a network interface controller including a hardware port; and
a virtual switch comprising software executed by said processor and including a plurality of virtual ports, said virtual ports adapted to be provide communication with an application running on said processor and said network interface controller.

14. The network of claim 13 further comprising a plurality of applications running on said processor and said virtual switch includes virtual ports adapted to provide communication with all of said applications.

15. The network of claim 13 further comprising a plurality of network interface controllers, each adapted to communicate with the virtual switch via a virtual port.

16. The network of claim 13 wherein said application submits a requests for an application port identifier (“APID”) to use when communicating with the virtual port of the virtual switch.

17. The network of claim 13 wherein said application is granted an application port identifier (“APID”) to use when communicating with the virtual port of the virtual switch.

18. The network of claim 13 wherein said virtual switch permits packets to be routed from said application to said network interface controller.

19. The network of claim 13 further comprising a plurality of applications running on said processor and said virtual switch includes virtual ports adapted to provide communication with all of said applications, and wherein said virtual switch permits packets to be routed from any of said applications to another of said applications.

20. The network of claim 19 further comprising a plurality of network interface controllers, each having at least one hardware port, and wherein said virtual switch permits packets to be routed from any of said applications to any said network interface controllers' hardware ports.

21. The network of claim 20 wherein said virtual switch permits packets to be routed from any of said network interface controllers' hardware ports to any other of said network interface controllers' hardware ports.

22. The network of claim 13 wherein said virtual switch receives a packet and accesses source route information contained in the packet, said source route information includes port identifiers associated with hardware and/or virtual ports specifying the route the packet takes through a network, and said virtual switch determines whether a pointer that is also contained in the packet is pointing to a port identifier associated with a hardware port or a virtual port.

23. The network of claim 22 wherein said virtual switch determines whether the packet is at the end of its route through the network and causes the packet to be consumed.

24. The electronic system of claim 23 wherein, if the packet is at the end of its route, the virtual switch determines whether an application exists that the packet is targeted for and provides the packet to that application if it exists.

25. A computer readable storage medium storing instructions that when executed by a processor cause the processor to implement a virtual switch which receives messages and forwards the messages to a target destination, said instructions comprising:
determining whether a packet was received over a hardware port or a virtual port;
extracting source route information from the packet;
extracting a pointer from the packet; and
forwarding the packet to a hardware or virtual port identified in the source information by the pointer if the packet is not at its destination.

26. The invention of claim 25 further including registering an application with a virtual switch to thereby provide a virtual port identifier to said application.

27. The invention of claim 25 further including processing said packet if the packet is at its destination.

28. The invention of claim 27 further including providing the packet to an application.

29. A method, comprising:
determining whether a packet was received over a hardware port or a virtual port;
extracting source route information from the packet;
extracting a pointer from the packet; and
forwarding the packet to a hardware or virtual port identified in the source information by the pointer if the packet is not at its destination.

30. The method of claim 29 further including registering an application with a virtual switch to thereby provide a virtual port identifier to said application.

31. The method of claim 29 further including processing said packet if the packet is at its destination.

32. The method of claim 31 further including providing the packet to an application.

33. A virtual switch adapted to couple to a network interface controller, comprising:
software executed by a processor; and
a plurality of virtual ports adapted to, provide communication with an application running on said processor and said network interface controller.

34. The virtual switch of claim 33 wherein said virtual switch permits packets to be routed from said application to said network interface controller.

35. The virtual switch of claim 33 wherein said virtual switch receives a packet and accesses source route information contained in the packet, said source route information includes port identifiers associated with hardware and/or virtual ports specifying the route the packet takes through a network, and said virtual switch determines whether a pointer that is also contained in the packet is pointing to a port identifier associated with a hardware port or a virtual port.

36. An electronic system, comprising:
a processor;
a network interface controller including a hardware port; and
means for providing communication with an application running on said processor and said network interface controller.
